(19) United States
(12) Patent Application Publication
(10) Pub. No.: US 2025/0363761 A1
(43) Pub. Date: Nov. 27, 2025

(54) VIDEO PROCESSING METHOD, VIDEO PROCESSING SYSTEM, AND NON-TRANSITORY COMPUTER-READABLE STORAGE MEDIUM STORING VIDEO PROCESSING PROGRAM

(71) Applicant: Yamaha Corporation, Hamamatsu (JP)

(72) Inventor: Akira MAEZAWA, Yokohama (JP)

(21) Appl. No.: 19/291,837

(22) Filed: Aug. 6, 2025

Related U.S. Application Data
(63) Continuation of application No. PCT/JP2024/008009, filed on Mar. 4, 2024.

(30) Foreign Application Priority Data
Mar. 10, 2023 (JP) 2023-037114

(51) Int. Cl. G06T 19/20; G06V 20/40; G06V 40/10

(52) U.S. Cl. CPC G06T 19/20; G06V 20/46; G06V 40/107; G06T 2207/10016

(57) ABSTRACT

A video processing method includes extracting, from a performance video representing a performance of a first keyboard instrument by a performer, a first reference portion that includes a hand of the performer. The video processing method further includes superimposing the first reference portion on a keyboard portion of a second keyboard instrument, thereby generating a composite video.

### CROSS-REFERENCE TO RELATED APPLICATIONS

This application is a continuation application of International Application No. PCT/JP2024/008009, filed on Mar. 4, 2024, which claims priority to Japanese Patent Application No. 2023-037114 filed in Japan on Mar. 10, 2023. The entire disclosures of International Application No. PCT/JP2024/008009 and Japanese Patent Application No. 2023-037114 are hereby incorporated herein by reference.

### BACKGROUND

### Technical Field

This disclosure generally relates to a technique for processing video.

### Background Information

Various techniques for providing video representing the state of a performance of a keyboard instrument have been proposed in the prior art. For example, International Publication No. 2017/029915 (hereinafter referred to as Patent Document 1) discloses a configuration in which a virtual image including a joint motion image, generated by analyzing motions of a performer playing a musical instrument, and a body change image representing bodily changes during the performance, is superimposed on an image of a visual field that is viewed by a user, and is displayed on a display device.

For example, there is demand for watching video of a desired performer playing a desired keyboard instrument. In Patent Document 1, since it is necessary to detect the performance by the player with various sensors, it is, in reality, difficult to generate a video that meets the demand described above. Given the circumstances described above, an object of one aspect of the present disclosure is to easily generate a video that appears as if a desired performer is playing a desired keyboard instrument.

### SUMMARY

In order to solve the problem described above, a video processing method according to one aspect of the present disclosure comprises extracting, from a performance video representing a performance of a first keyboard instrument by a performer, a first reference portion that includes a hand of the performer, and superimposing the first reference portion on a keyboard portion of a second keyboard instrument to generate a composite video.

A video processing system according to an aspect of this disclosure comprises a controller including a memory storing instructions and at least one processor that implements the instructions, the instructions comprising extracting, from a performance video representing a performance of a first keyboard instrument by a performer, a first reference portion that includes a hand of the performer and superimposing the first reference portion on a keyboard portion of a second keyboard instrument, thereby generating a composite video.

A non-transitory computer-readable storage medium storing a program according to an aspect of this disclosure executes by at least one processor of a computer system to perform a video processing method, the video processing method comprising extracting, from a performance video representing a performance of a first keyboard instrument by a performer, a first reference portion that includes a hand of the performer and superimposing the first reference portion on a keyboard portion of a second keyboard instrument, thereby generating a composite video.

### BRIEF DESCRIPTION OF THE DRAWINGS

FIG. 1 is a block diagram of a video system according to a first embodiment.

FIG. 2 is a block diagram of a display system.

FIG. 3 is a schematic diagram of a performance video.

FIG. 4 is a block diagram illustrating a functional configuration of a video processing system.

FIG. 5 is a schematic diagram of a composite video.

FIG. 6 is a schematic diagram of a virtual space.

FIG. 7 is a flowchart of a video generation process FIG. 8 is a schematic diagram of a performance video in a second embodiment.

FIG. 9 is a schematic diagram of a composite video in the second embodiment.

FIG. 10 is a schematic diagram of a virtual space in the second embodiment.

FIG. 11 is a flowchart of a video generation process in the second embodiment.

FIG. 12 is an explanatory diagram of depth control using depth information.

FIG. 13 is a flowchart of a video generation process in a third embodiment.

FIG. 14 is a block diagram of a display unit in a fourth embodiment.

FIG. 15 is a flowchart of a video generation process in the fourth embodiment.

FIG. 16 is a schematic diagram of a composite video in a modified example.

### DETAILED DESCRIPTION OF THE EMBODIMENTS

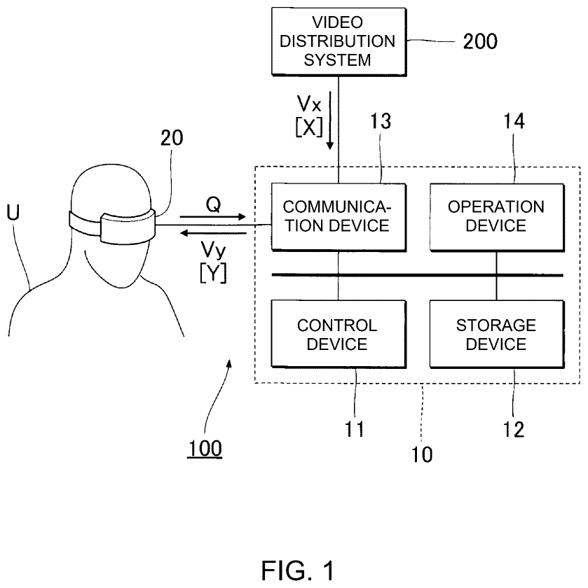

FIG. 1 is a block diagram showing the configuration of a video system 100 according to the first embodiment. The video system 100 according to the first embodiment is a computer system for providing a user U with a video (hereinafter referred to as “composite video Y”) in which a specific performer (hereinafter referred to as “target performer P”) plays a keyboard instrument. The video system 100 comprises a video processing system 10 and a display unit 20.

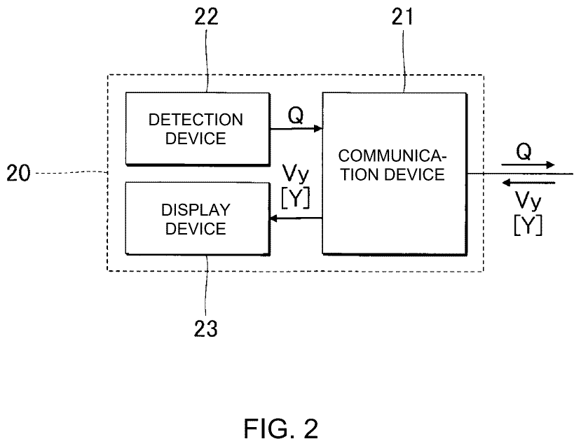

The display unit 20 is a video device (HMD: Head Mounted Display) that is mounted on a head of the user U. For example, a goggle-type or eyeglass-type HMD is used as the display unit 20. FIG. 2 is a block diagram illustrating a configuration of the display unit 20. The display unit 20 of the first embodiment comprises a communication device 21, a detection device 22, and a display device 23.

The detection device 22 is a sensor that outputs a detection signal Q corresponding to the orientation of the display unit 20. Specifically, the detection device 22 comprises a sensor such as a gyro sensor that detects angular velocity or an acceleration sensor that detects acceleration. As described above, since the display unit 20 is mounted on the head of the user U, the detection signal Q generated by the detection device 22 can also be expressed as a signal representing the orientation of the head of the user U.

The communication device 21 communicates with the video processing system 10 by wire or wirelessly. For example, the communication device 21 transmits, to the video processing system 10, the detection signal Q generated by the detection device 22. In addition, the communication device 21 receives, from the video processing system 10, video data Vy representing the composite video Y.

The display device 23 displays an image under the control of the video processing system 10. Specifically, the display device 23 processes the video data Vy received by the communication device 21 to display the composite video Y. For example, various display panels such as a liquid-crystal display panel or an organic EL (electroluminescent) display panel are employed as the display device 23. The display device 23 is a non-transmissive display panel that does not transmit light arriving from real space, and is placed in front of both eyes of the user U. The composite video Y is a stereoscopic video composed of a right-eye image and a left-eye image. The display device 23 displays the composite video Y, thereby making it possible for the user U to perceive three-dimensionality.

The video processing system 10 of FIG. 1 is a computer system for generating the composite video Y. The video processing system 10 is realized by an information device such as a smartphone, a tablet terminal, or a personal computer. The video processing system 10 comprises a control device 11, a storage device 12, a communication device 13, and an operation device 14. The video processing system 10 can be realized as a single device, or as a plurality of devices which are separately configured. The video processing system 10 can be mounted on the display unit 20. In addition, the display unit 20 can be interpreted as a constituent element of the video processing system 10.

The control device 11 is one or more processors that control each element of the video processing system 10. Specifically, the control device 11 comprises one or more types of processors, such as a CPU (Central Processing Unit), a GPU (Graphics Processing Unit), an SPU (Sound Processing Unit), a DSP (Digital Signal Processor), an FPGA (Field Programmable Gate Array), an ASIC (Application Specific Integrated Circuit), and the like.

The storage device 12 comprises one or more memory units for storing a program that is executed by the control device 11 and various data that are used by the control device 11. A known storage medium, such as a magnetic storage medium or a semiconductor storage medium, or a combination of a plurality of various types of storage media can be used as the storage device 12. Note that, for example, a portable storage medium that is attached to/detached from the video processing system 10 or a storage medium (for example, cloud storage) that the control device 11 can access via a communication network can also be used as the storage device 12.

The operation device 14 is an input device that accepts instructions from the user U. The operation device 14 is, for example, an operator or a touch panel operated by the user U. Note that the operation device 14 that is separate from the video processing system 10 can be connected to the video processing system 10 wirelessly or by wire.

The communication device 13 communicates with an external device by wire or wirelessly. Specifically, the communication device 13 communicates with the display unit 20. For example, the communication device 13 receives, from the display unit 20, the detection signal Q generated by the detection device 22. In addition, the communication device 13 transmits, to the display unit 20, the video data Vy representing the composite video Y.

In addition, the communication device 13 communicates with a video distribution system 200 via a communication network (not shown), such as the Internet. The video distribution system 200 is a distribution server device that distributes video (hereinafter referred to as “performance video”) X that is used as a material for the composite video Y. Specifically, the video distribution system 200 transmits video data Vx representing the performance video X. The communication device 13 receives the video data Vx transmitted from the video distribution system 200. The format of the video data Vx can be freely selected.

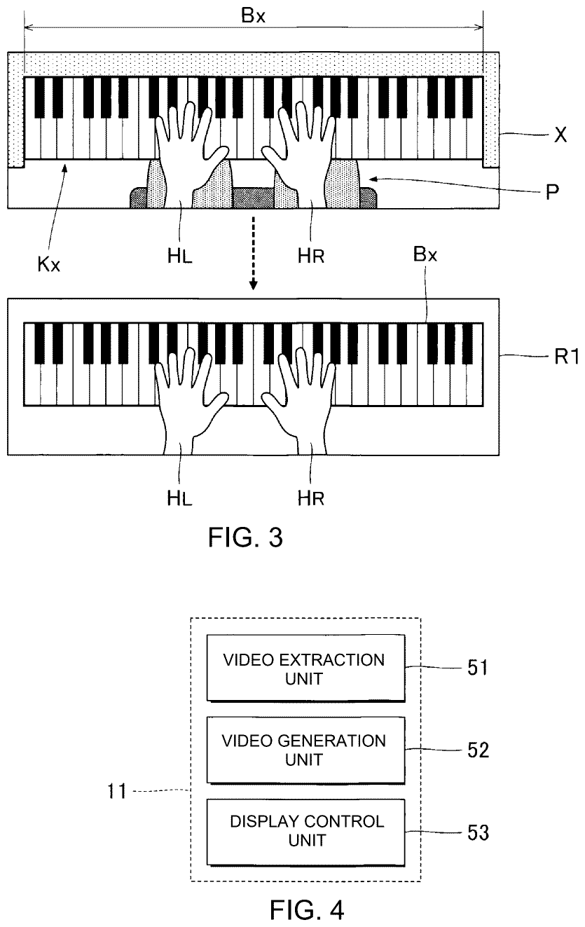

FIG. 3 is a schematic diagram of the performance video X. The performance video X is video representing a state in which the target performer P is playing a keyboard instrument Kx. For example, an image of the target performer P and the keyboard instrument Kx that are real is captured in real space to record the performance video X. Specifically, the performance video X includes a keyboard Bx of the keyboard instrument Kx, and the right hand HR and the left hand HL of the target performer P. The performance video X is existing video (for example, so-called cover videos) stored in the video distribution system 200. The keyboard instrument Kx is one example of a “first keyboard instrument.” The video processing system 10 processes the performance video X to generate the composite video Y.

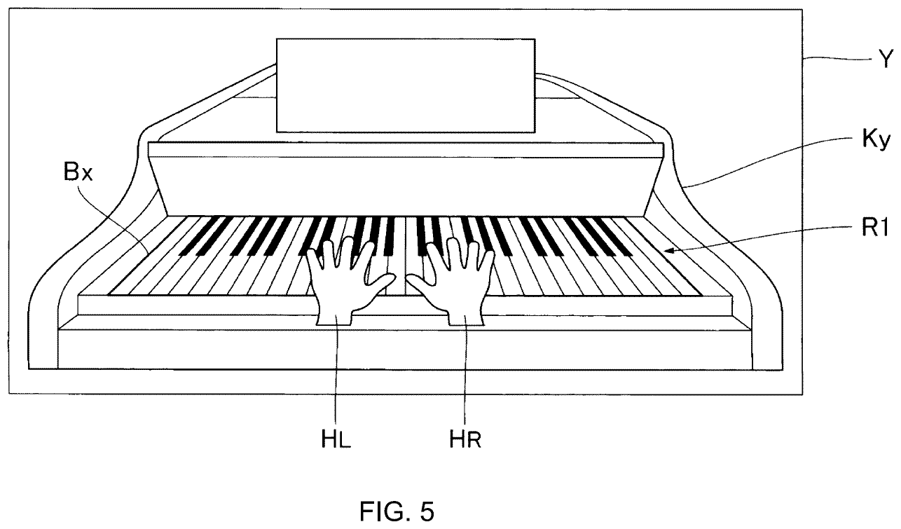

FIG. 4 is a block diagram illustrating a functional configuration of the video processing system 10. The control device 11 executes programs stored in the storage device 12 to realize a plurality of functions (a video extraction unit 51, a video generation unit 52, and a display control unit 53) for generating the composite video Y.

As shown in FIG. 3, the video extraction unit 51 extracts a first reference portion R1 from the performance video X represented by the video data Vx. The first reference portion R1 is video constituting a part of the performance video X. Specifically, the first reference portion R1 is video including the right hand HR and the left hand HL of the target performer P and the keyboard Bx of the keyboard instrument Kx in the performance video X. For example, the video extraction unit 51 replaces, with a transparent image, areas of the performance video X other than areas composed of the right hand HR, the left hand HL, and the keyboard Bx. Any known technique can be employed for the extraction of the first reference portion R1, such as object detection (semantic segmentation) that uses a trained model, such as a deep neural network.

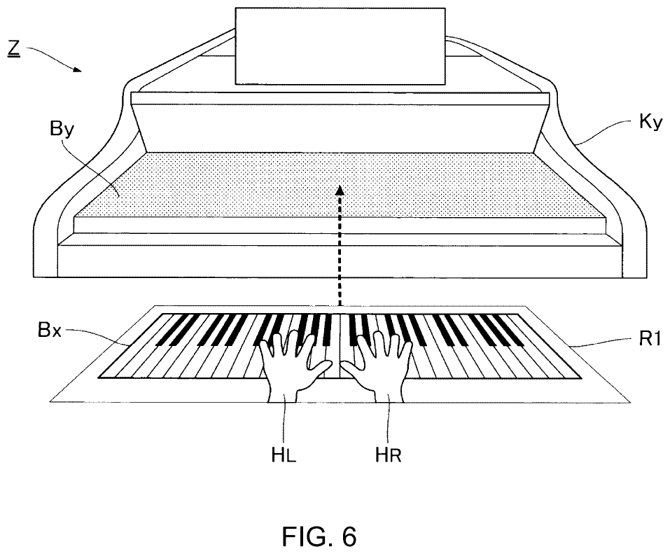

The video generation unit 52 of FIG. 4 generates the composite video Y by using the first reference portion R1. FIG. 5 is a schematic diagram of the composite video Y. The composite video Y according to the first embodiment is video representing a virtual space Z. The composite video Y is actually a stereoscopic video composed a right-eye image and a left-eye image, but is illustrated as one image in FIG. 5 for the sake of convenience.

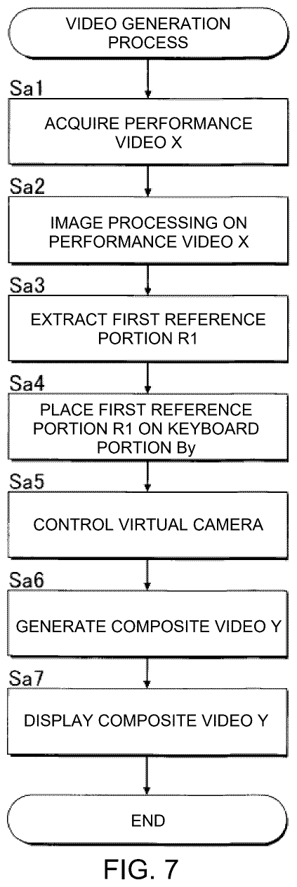

FIG. 6 is a schematic diagram of the virtual space Z. A virtual camera (not shown) is placed in the virtual space Z. The virtual camera is a virtual imaging device that captures an image of the virtual space Z. The composite video Y is video captured by the virtual camera in the virtual space Z.

As shown in FIG. 6, a virtual keyboard instrument (hereinafter referred to as “target keyboard instrument Ky”) is placed in the virtual space Z. The target keyboard instrument Ky is a virtual display object having an outer appearance that mimics a grand piano, which is a natural musical instrument. For example, a plurality of display objects corresponding to different types of keyboard instruments are pre-stored in the storage device 12. Of the plurality of display objects pre-stored in the storage device 12, the video generation unit 52 places in the virtual space Z, as the target keyboard instrument Ky, a display object selected by the user U through an operation of the operation device 14. The target keyboard instrument Ky is one example of a “second keyboard instrument.”

As shown in FIG. 6, the target keyboard instrument Ky includes a keyboard portion By. The keyboard portion By is the portion corresponding to the keyboard of the target keyboard instrument Ky. A keyboard is not placed on the target keyboard instrument Ky. That is, the keyboard portion By is a virtual flat surface on which a keyboard should exist in a natural musical instrument.

As shown in FIGS. 5 and 6, the video generation unit 52 superimposes the first reference portion R1 on the keyboard portion By of the target keyboard instrument Ky in the virtual space Z, thereby generating the composite video Y. The first reference portion R1 is placed on the keyboard portion By as a display object in the virtual space Z. That is, the target keyboard instrument Ky in a state in which the first reference portion R1 is placed on the keyboard portion By is imaged by the virtual camera in the virtual space Z. Accordingly, the composite video Y appearing as if the target performer P were playing the target keyboard instrument Ky is displayed on the display device 23.

The video generation unit 52 controls the position and orientation of the virtual camera in the virtual space Z in accordance with the detection signal Q received by the communication device 13. Accordingly, the virtual line of sight in the composite video Y is controlled in accordance with the orientation of the head of the user U detected by the detection device 22. Well-known image processing, such as 3D rendering, is used for the generation of the composite video Y.

The display control unit 53 of FIG. 4 displays the composite video Y on the display device 23. Specifically, the display control unit 53 transmits, from the communication device 13 to the display unit 20, the video data Vy representing the composite video Y. The format of the video data Vy can be freely selected. As can be understood from the foregoing explanation, the display unit 20 of the first embodiment displays the composite video Y by virtual reality (VR).

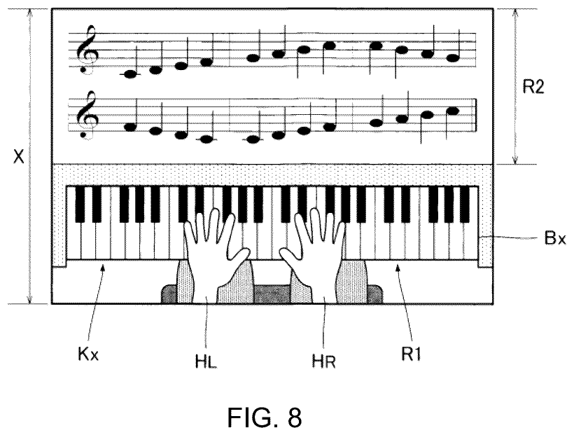

FIG. 7 is a flowchart of a process (hereinafter referred to as “video generation process”) for generating the composite video Y. For example, the video generation process is executed for each frame of the performance video X.

When the video generation process is started, the control device 11 (the video extraction unit 51) acquires the performance video X (Sa1). Specifically, the control device 11 receives the video data Vx through the communication device 13. The control device 11 (the video extraction unit 51) executes image processing on the performance video X (Sa2). The image processing includes a correction process for correcting the keyboard Bx in the performance video X to have a prescribed size and shape. The correction process is, for example, the well-known keystone correction. The control device 11 (the video extraction unit 51) extracts the first reference portion R1 from the corrected performance video X (Sa3).

The control device 11 (the video generation unit 52) places the first reference portion R1 on the keyboard portion By of the target keyboard instrument Ky set in the virtual space Z (Sa4). In addition, the control device 11 (the video generation unit 52) sets the position and orientation of the virtual camera in the virtual space Z in accordance with the orientation represented by the detection signal Q (Sa5). Then, the control device 11 (the video generation unit 52) generates the composite video Y obtained by imaging, with the virtual camera, the target keyboard instrument Ky and the first reference portion R1 in the virtual space Z (Sa6). The control device 11 (the display control unit 53) transmits the video data Vy representing the composite video Y from the communication device 13 to the display unit 20, thereby displaying the composite video Y on the display device 23 (Sa7).

As described above, in the first embodiment, the first reference portion R1 extracted from the performance video X is superimposed on the keyboard portion By of the target keyboard instrument Ky. Accordingly, it is possible to easily generate the composite video Y appearing as if the target performer P in the performance video X were playing the target keyboard instrument Ky.

In the first embodiment, the keyboard Bx of the keyboard instrument Kx is extracted as the first reference portion R1, together with the right hand HR and the left hand HL of the target performer P, and the first reference portion R1 is superimposed on the keyboard portion By of the target keyboard instrument Ky. Accordingly, it is possible to generate the composite video Y in which the right hand HR and the left hand HL of the target performer P and the keyboard Bx of the first reference portion R1 are in a natural positional relationship.

In particular, in the first embodiment, the first reference portion R1 is superimposed on the target keyboard instrument Ky in the virtual space Z. Accordingly, it is possible to generate the composite video Y in which the target performer P appears to be playing various target keyboard instruments Ky, including keyboard instruments that do not actually exist. That is, it is possible to provide the user U with a unique customer experience of watching a state in which the desired target performer P of the user U plays the target keyboard instrument Ky having the desired appearance.

The second embodiment will be described. In each of the embodiments illustrated below, elements that have the same functions as those in first embodiment have been assigned the same reference symbols used to describe the first embodiment and detailed descriptions thereof have been appropriately omitted.

FIG. 8 is a schematic diagram of a performance video X in the second embodiment. The performance video X of the second embodiment includes a second reference portion R2 in addition to the first reference portion R1 (HR, HL, Bx) that is the same as that in the first embodiment. The second reference portion R2 is video representing the content of a performance by the target performer P. Specifically, the second reference portion R2 includes a musical score of a musical piece played by the target performer P.

The video extraction unit 51 of the second embodiment extracts the second reference portion R2 from the performance video X, in addition to the first reference portion R1. Any known technique can be employed for the extraction of the second reference portion R2, in the same manner as the extraction of the first reference portion R1.

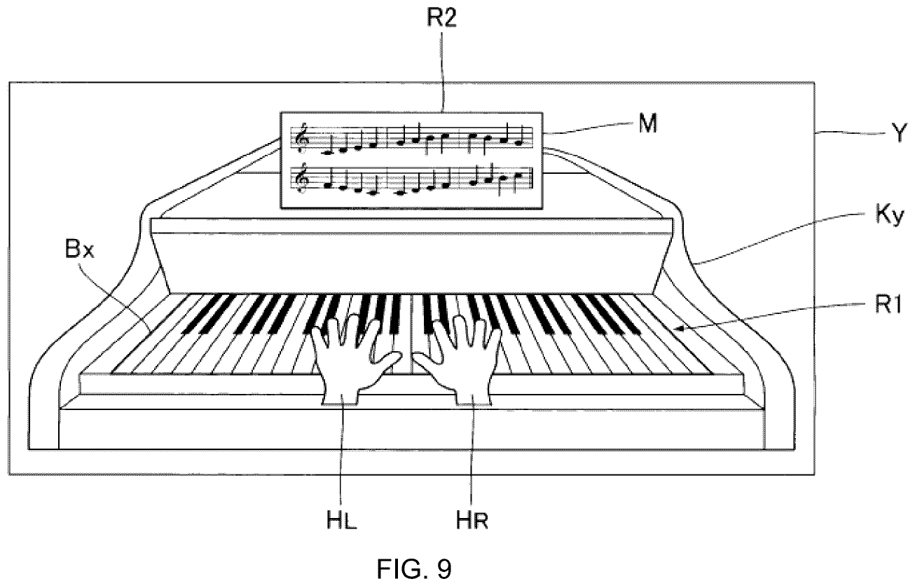

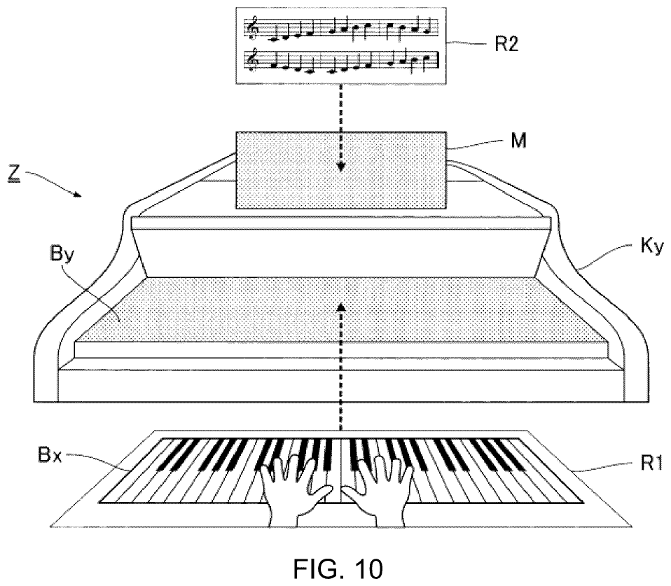

FIG. 9 is a schematic diagram of the composite video Y in the second embodiment, and FIG. 10 is a schematic diagram of the virtual space Z in the second embodiment. As shown in FIGS. 9 and 10, the video generation unit 52 of the second embodiment superimposes the first reference portion R1 and the second reference portion R2 on the target keyboard instrument Ky in the virtual space Z. The first reference portion R1 is placed on the keyboard portion By of the target keyboard instrument Ky, in the same manner as in the first embodiment. On the other hand, the second reference portion R2 is placed on a music rack portion M of the target keyboard instrument Ky in the virtual space Z.

The music rack portion M is the portion of the target keyboard instrument Ky corresponding to the music rack. Specifically, the music rack portion M is a virtual flat surface that extends vertically above and behind the keyboard portion By. Accordingly, the keyboard portion By and the music rack portion M intersect with each other.

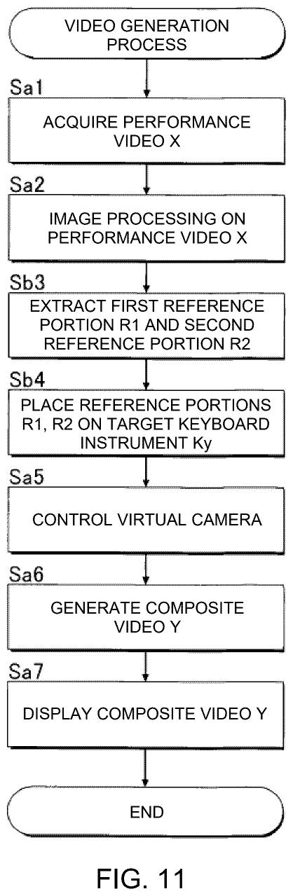

FIG. 11 is a flowchart of a video generation process in the second embodiment. When the video generation process is started, the control device 11 (the video extraction unit 51) acquires the performance video X (Sa1) and executes image processing (Sa2) on the performance video X, in the same manner as in the first embodiment. The control device 11 (the video extraction unit 51) extracts the first reference portion R1 and the second reference portion R2 from the performance video X (Sb3).

The control device 11 (the video generation unit 52) places the first reference portion R1 on the keyboard portion By of the target keyboard instrument Ky set in the virtual space Z, and places the second reference portion R2 on the music rack portion M of the target keyboard instrument Ky (Sb4). The control device 11 (the video generation unit 52) sets the virtual camera (Sa5) and generates the composite video Y (Sa6), in the same manner as in the first embodiment. In addition, the control device 11 (the display control unit 53) transmits, from the communication device 13 to the display unit 20, the video data Vy of the composite video Y (Sa7).

The same effects as those of the first embodiment are realized in the second embodiment. In addition, in the second embodiment, the second reference portion R2 representing the content of a performance by the target performer P is displayed together with the target keyboard instrument Ky, so that the user U can watch the state of the performance by the target performer P while visually checking the second reference portion R2. For example, it is possible to provide the user U with a unique customer experience of watching a performance by the target performer P while constantly checking the musical score of the musical piece being played.

In particular, in the second embodiment, the second reference portion R2 is extracted from the performance video X. Accordingly, for example, compared to a configuration in which the second reference portion R2 is prepared separately from the performance video X, the configuration and processing for generating the composite video Y are simplified.

The video extraction unit 51 of the third embodiment generates depth information D of the first reference portion R1 in addition to the extraction of the first reference portion R1 from the performance video X as in the first embodiment. The depth information D is data representing the depth at the surface of the right hand HR and the left hand HL of the target performer P in the first reference portion R1. For example, the depth information D includes the depth at the surface of the right hand HR and the left hand HL of the target performer P for each pixel of the first reference portion R1. The depth is expressed as the distance from a specific reference plane (for example, the surface of the keyboard Bx in the performance video X), for example.

Any well-known technique can be employed for the generation of the depth information D by the video extraction unit 51. Specifically, depth estimation using a trained model (for example, MiDaS), such as a deep neural network, can be used for the generation of the depth information D.

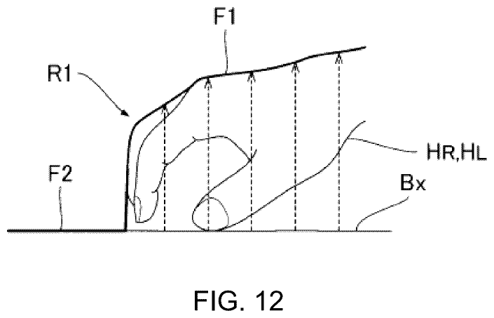

As shown in FIG. 12, the video generation unit 52 according to the third embodiment controls, in accordance with the depth information D, the depth at the surface of the right hand HR and the left hand HL of the target performer P in the first reference portion R1. Specifically, as can be understood from the example shown in FIG. 12, the surface F1 of the right hand HR and the left hand HL is set at a higher position than the surface F2 of the keyboard Bx. That is, the right hand HR and the left hand HL of the target performer P project out from the surface F2.

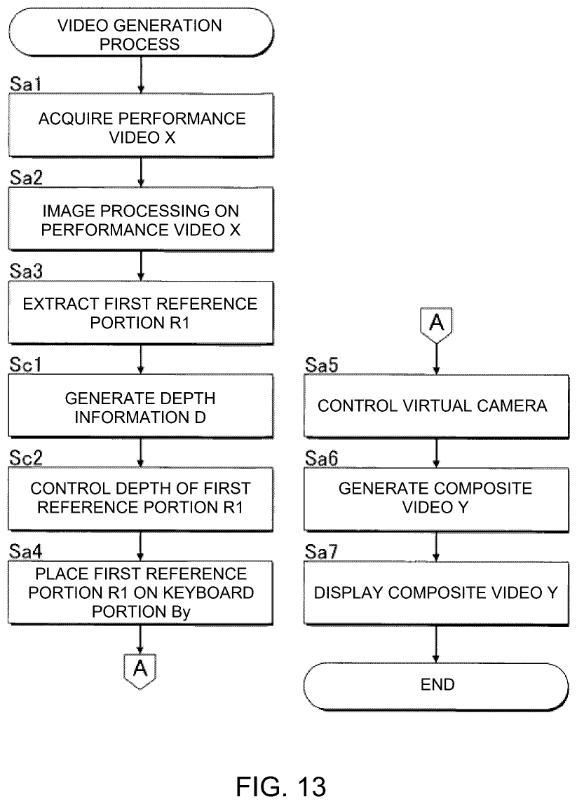

FIG. 13 is a flowchart of a video generation process in the third embodiment. When acquisition of the performance video X (Sa1) and the image processing on the performance video X (Sa2) are executed in the same manner as in the first embodiment, the control device 11 (the video extraction unit 51) extracts the first reference portion R1 from the performance video X (Sa3). The control device 11 (the video extraction unit 51) generates the depth information D of the first reference portion R1 (Sc1).

The control device 11 (the video generation unit 52) controls, in accordance with the depth information D, the depth of the surface F1 of the right hand HR and the left hand HL of the target performer P in the first reference portion R1 (Sc2). The control device 11 (the video generation unit 52) places the first reference portion R1 after depth control in the keyboard portion By of the target keyboard instrument Ky in the virtual space Z (Sa4). The subsequent operations (Sa5 to Sa7) are the same as in the first embodiment.

The same effects as those of the first embodiment are realized in the third embodiment. In addition, in the third embodiment, depth corresponding to the depth information D is imparted to the hands H (HR, HL) of the target performer P in the first reference portion R1, so that it is possible to generate the composite video Y in which the hands H of the target performer P are displayed with a three-dimensional effect close to that of an actual performance. That is, it is possible to provide the user U with a unique customer experience of watching a performance by the target performer P while checking the hands H of the target performer P with high sense of reality. The configuration of the second embodiment in which the second reference portion R2 is superimposed on the target keyboard instrument Ky can also be applied to the third embodiment.

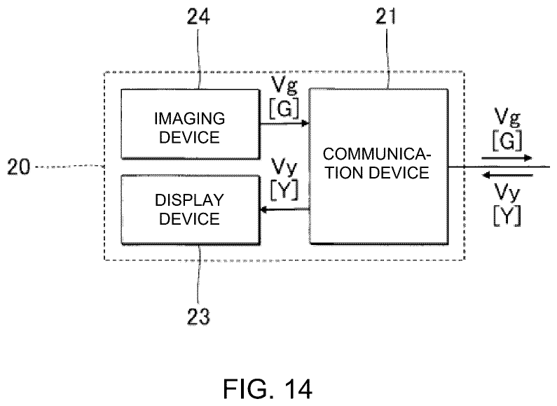

FIG. 14 is a block diagram of the display unit 20 in a fourth embodiment. The display unit 20 of the fourth embodiment has a configuration in which the detection device 22 in the first embodiment is replaced with an imaging device 24. That is, in the fourth embodiment, the display device 23 and the imaging device 24 are mounted on the head of the user U. The display device 23 is a non-transmissive display panel, in the same manner as in the first embodiment.

The imaging device 24 images a real space in which the user U is located to thereby generate imaging data Vg. The imaging data Vg are data in a given format representing video (hereinafter referred to as “recorded video G”) in real space. Specifically, the imaging device 24 comprises an optical system such as a photographic lens, an imaging element that receives incident light from the optical system, and a processing circuit that generates the imaging data Vg corresponding tow the amount of light received by the imaging element.

The imaging device 24 images in front of the head (that is, the direction of the line of sight) of the user U. The user U maintains a state in which the head is facing the keyboard instrument placed in real space. Accordingly, the recorded video G includes the keyboard instrument in the real space. In the fourth embodiment, the composite video Y is generated with a real keyboard instrument included in the recorded video G as the target keyboard instrument Ky. That is, the control device 11 (the video generation unit 52) superimposes the first reference portion R1 on the keyboard portion By of the target keyboard instrument Ky included in the recorded video G, thereby generating the composite video Y. The keyboard portion By of the fourth embodiment is the keyboard of the real keyboard instrument placed in real space.

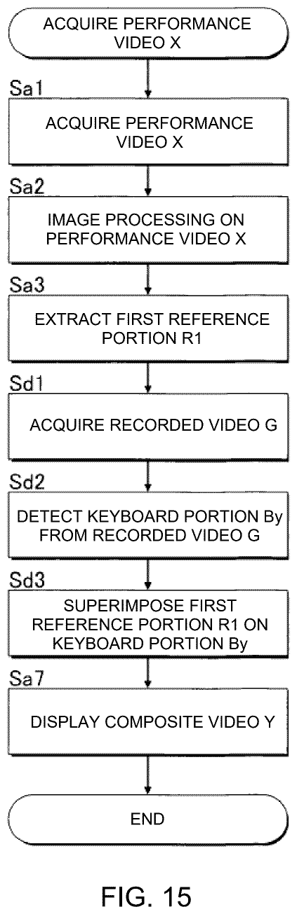

FIG. 15 is a flowchart of a video generation process in the fourth embodiment. For example, the video generation process is executed for each frame of the performance video X.

When the video generation process is started, the control device 11 (the video extraction unit 51) acquires the performance video X (Sa1) and executes image processing (Sa2) on the performance video X, in the same manner as in the first embodiment. In addition, the control device 11 (the video extraction unit 51) extracts the first reference portion R1 from the performance video X, in the same manner as in the first embodiment (Sa3).

The control device 11 (the video extraction unit 51) acquires the recorded video G including the target keyboard instrument Ky in real space (Sd1). Specifically, the control device 11 receives the imaging data Vg transmitted from the display unit 20 through the communication device 13.

The control device 11 (the video extraction unit 51) detects the keyboard portion By of the target keyboard instrument Ky from the recorded video G represented by the imaging data Vg (Sd2). Any known technique can be employed for the detection of the target keyboard instrument Ky, such as object detection that uses a trained model, such as a deep neural network. The order of the extraction of the first reference portion R1 (Sa1 to Sa3) and the extraction of the keyboard portion By (Sd1, Sd2) can be reversed.

The control device 11 (the video generation unit 52) superimposes the first reference portion R1 on the keyboard portion By of the recorded video G, thereby generating the composite video Y (Sd3). That is, the composite video Y is generated in which the first reference portion R1 is placed on the keyboard portion By with the recorded video G as the background. The control device 11 (the display control unit 53) transmits, from the communication device 13 to the display unit 20, the video data Vy representing the composite video Y, in the same manner as in the first embodiment (Sa7). As can be understood from the foregoing explanation, the display unit 20 of the fourth embodiment displays the composite video Y by augmented reality (AR) or mixed reality (MR).

As described above, in the fourth embodiment, the first reference portion R1 is superimposed on the keyboard portion By of the target keyboard instrument Ky in real space in which the imaging device 24 is installed. Accordingly, it is possible to generate the composite video Y in which the target performer P of the performance video X appears to be playing the target keyboard instrument Ky in real space, such as a keyboard instrument owned by the user U.

In particular, in the fourth embodiment, the display device 23 and the imaging device 24 are mounted on the head of the user U. In the foregoing configuration, the position and angle of the display device 23 and the imaging device 24 change in accordance with the position and angle of the head of the user U. That is, the position and angle of the target keyboard instrument Ky in the composite video Y displayed on the display device 23 change in conjunction with the motion of the head of the user U. Accordingly, the user U can perceive a sensation as if the target performer P were actually present in the real space in which the user U is located. That is, it is possible to provide the user U with a unique customer experience as if the target performer P were present near the user U.

The configuration of the second embodiment in which the second reference portion R2 is superimposed on the target keyboard instrument Ky can also be applied to the fourth embodiment. That is, the second reference portion R2 of the performance video X is superimposed on the music rack portion M of the target keyboard instrument Ky included in the recorded video G. In addition, the configuration of the third embodiment in which the depth of the first reference portion R1 is adjusted using the depth information D can also be applied to the fourth embodiment. For example, in the fourth embodiment, the first reference portion R1 in which the depth of the surface F1 of the right hand HR and the left hand HL of the target performer P is controlled in accordance with the depth information D can be superimposed on the keyboard portion By of the target keyboard instrument Ky.

Specific modified embodiments to be added to each of the embodiments exemplified above are illustrated below. Two or more embodiments arbitrarily selected from the following examples can be appropriately combined insofar as they are not mutually contradictory.

(1) In each of the embodiments described above, an example was shown in which the first reference portion R1 includes the keyboard Bx of the keyboard instrument Kx in addition to the right hand HR and the left hand HL of the target performer P, but the keyboard Bx can be omitted from the first reference portion R1. That is, the extraction of the keyboard Bx by the video extraction unit 51 can be omitted, and the first reference portion R1 composed of the right hand HR and the left hand HL of the target performer P can be superimposed on the keyboard portion By of the target keyboard instrument Ky. In a configuration in which the first reference portion R1 does not include the keyboard Bx, it is preferable that the target keyboard instrument Ky in the virtual space Z includes a keyboard. According to the configuration described above, the composite video Y is generated in which the target performer P plays a virtual keyboard of the target keyboard instrument Ky in the virtual space Z.

(2) The performance video X is not limited to video recorded in real space. For example, video in which a virtual camera has captured the virtual target performer P and the virtual target keyboard instrument Ky located in virtual space can be used as the performance video X.

(3) In each of the embodiments described above, an example is shown in which the composite video Y is displayed on the display device 23, but the method of outputting the composite video Y is not limited to the example described above. For example, the video data Vy of the composite video Y can be transmitted to and stored in the video distribution system 200. The video distribution system 200 distributes the video data Vy to an information device, such as a smartphone, in response to a request from said information device.

(4) For example, the video processing system 10 can be realized by a server device that communicates with the display unit 20 via a communication network. The video data Vy of the composite video Y generated by the video processing system 10 are transmitted to the display unit 20 via the communication network, whereby the composite video Y is displayed on the display device 23.

(5) In each of the embodiments described above, a non-transmissive display panel is used as the display device 23, but a transmissive display panel that transmits light arriving from real space can be used as the display device 23. In a configuration in which a transmissive display panel is used as the display device 23, the first reference portion R1 (and further the second reference portion R2) is superimposed on a real keyboard instrument visible to the user U via the display device 23 (that is, an optical image), the real keyboard instrument serving as the target keyboard instrument Ky in the background.

(6) In each of the embodiments described above, a direct-view display device 23 that the user directly views is used as an example, but the composite video Y can be displayed by a projection-type display device that projects an image onto a projection surface, for example. For example, a projection-type display device projects the first reference portion R1 and the second reference portion R2 on the keyboard portion By of a keyboard instrument (the target keyboard instrument Ky) located in real space.

(7) In the second embodiment, the second reference portion R2 is extracted from the performance video X, but the method of acquiring the second reference portion R2 is not limited to the example described above. For example, the second reference portion R2 representing a musical score of a musical piece being played in the performance video X can be prepared separately from the performance video X and stored, for example, in the storage device 12. The video generation unit 52 superimposes the second reference portion R2 stored in the storage device 12 on the keyboard portion By of the target keyboard instrument Ky, thereby generating the composite video Y.

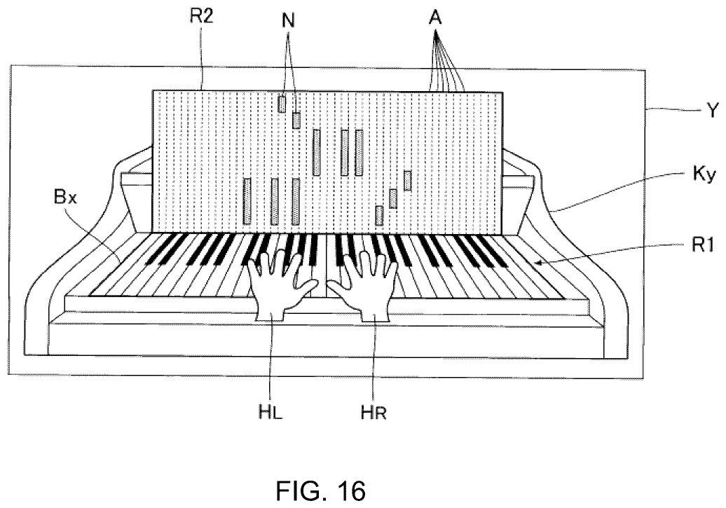

(8) In the second embodiment, a musical score of a musical piece is illustrated as an example of the second reference portion R2, but the second reference portion R2 is not limited to a musical score. For example, as shown in FIG. 16, a guide image representing the content of a performance by the target performer P can be included in the composite video Y as the second reference portion R2. For example, the guide image is extracted from the performance video X, in the same manner as the musical score in the second embodiment.

The guide image of FIG. 16 includes a plurality of unit areas A corresponding to different pitches. The plurality of unit areas A are arranged in the horizontal direction along the arrangement of the plurality of keys of the keyboard Bx. Each unit area A is an area elongated in the vertical direction. In the unit area A of each pitch, an indicator N is displayed providing guidance on the time point at which the pitch is to be played. The indicator N of each pitch moves from the upper end to the lower end of the unit area A so as to reach the lower end when said pitch is to be played. The display length of the indicator N in the vertical direction corresponds to the duration for which the pronunciation of each pitch should be maintained. Accordingly, the user U can visually check the guide image and ascertain the duration and time point of pronunciation of each pitch.

(9) As described above, the functions of the video processing system 10 used as an example above are realized by cooperation between one or more processors that constitute the control device 11, and a program stored in the storage device 12. The program according to the present disclosure can be provided in a form stored in a computer-readable storage medium and installed on a computer. The storage medium is, for example, a non-transitory storage medium, a good example of which is an optical storage medium (optical disc) such as a CD-ROM, but can include storage media of any known form, such as a semiconductor storage medium or a magnetic storage medium. Non-transitory storage media include any storage medium that excludes transitory propagating signals and does not exclude volatile storage media. In addition, in a configuration in which a distribution device distributes the program via a communication network, a storage medium that stores the program in the distribution device corresponds to the non-transitory storage medium.

For example, the following configurations can be understood from the embodiments exemplified above.

A video processing method according to one aspect (Aspect 1) of the present disclosure comprises extracting, from a performance video representing a performance of a first keyboard instrument by a performer, a first reference portion that includes the hands of the performer, and superimposing the first reference portion on a keyboard portion of a second keyboard instrument to generate a composite video. According to the aspect described above, the first reference portion extracted from the performance video is superimposed on the keyboard portion of the second keyboard instrument, so that it is possible to easily generate a composite video that appears as if a performer in the performance video were playing the second keyboard instrument.

The “second keyboard instrument” is a keyboard instrument separate from the first keyboard instrument. for example, a typical example of the second keyboard instrument is a virtual keyboard instrument placed in a virtual space. That is, the second keyboard instrument can be displayed as an image by means of virtual reality (VR). In addition, the second keyboard instrument can be a real keyboard instrument captured as an image in real space. The second keyboard instrument is displayed together with the first reference portion by means of augmented reality (AR) or mixed reality (MR). A real keyboard instrument observed in real space as an optical image can be displayed as the second keyboard instrument together with the first reference portion, by means of augmented reality or mixed reality.

The keyboard portion is the portion of the second keyboard instrument corresponding to the keyboard. For example, in a configuration in which the second keyboard instrument is a virtual keyboard instrument in virtual space, the portion of the second keyboard instrument in which the keyboard should be placed corresponds to the “keyboard portion.” Whether the virtual keyboard instrument comprises a keyboard is irrelevant. In a configuration in which the second keyboard instrument is a keyboard instrument in real space, the portion of the second keyboard instrument where the keyboard actually exists is the “keyboard portion.”

In a specific example (Aspect 2) of Aspect 1, the first reference portion further includes the keyboard of the first keyboard instrument. According to the aspect described above, the keyboard of the first keyboard instrument is extracted as the first reference portion together with the hands of the performer, and the first reference portion is superimposed on the keyboard portion of the second keyboard instrument. Accordingly, it is possible to generate a video in which the hands of the performer and the keyboard are in a natural positional relationship.

In a specific example (Aspect 3) of Aspect 1 or 2, when generating the composite video, a second reference portion representing the content of a performance by the performer is further superimposed on the second keyboard instrument. According to the aspect described above, since the second reference portion representing the content of a performance by the performer is displayed together with the second keyboard instrument, the user can appreciate the state of the performer's performance while checking the content of the performance by visually checking the second reference portion.

In a specific example (Aspect 4) of Aspect 3, the second reference portion is further extracted from the performance video. According to the aspect described above, the second reference portion is extracted from the performance video together with the first reference portion. Accordingly, for example, compared to a configuration in which the second reference portion is prepared separately from the performance video, the configuration and processing for generating the composite video are simplified.

In a specific example (Aspect 5) of any one of Aspects 1 to 4, depth information representing the depth at the surface of the hands of the performer is further generated from the performance video, and when generating the composite video, the depth of the surface of the hands of the performer in the first reference portion is controlled in accordance with the depth information. According to the aspect described above, depth corresponding to the depth information is imparted to the hands of the performer in the first reference portion, so that it is possible to generate a composite video in which the hands of the performer are displayed with a three-dimensional effect close to that of an actual performance.

In a specific example (Aspect 6) of any one of Aspects 1 to 5, recorded video including the second keyboard instrument in real space is further acquired from an imaging device, and when generating the composite video, the first reference portion is superimposed on the keyboard portion of the second keyboard instrument in the recorded video. According to the aspect described above, a composite video is generated in which the hands of the performer are superimposed on the second keyboard instrument in real space in which the imaging device is installed. Accordingly, it is possible to generate a composite video in which a performer appears to be playing a desired second keyboard instrument, such as a keyboard instrument owned by the user.

In a specific example (Aspect 7) of Aspect 6, the composite video is further displayed on the display device, and the display device and the imaging device are mounted on the head of a user. According to the aspect described above, the position and angle of the display device and the imaging device change in accordance with the position and angle of the head of the user. That is, the position and angle of the second keyboard instrument in the composite video displayed on the display device change in conjunction with the motion of the head of the user. Accordingly, the user can perceive a sensation as if the performer were actually present in the space in which the user is located.

In a specific example (Aspect 8) of any one of Aspects 1 to 5, when generating the composite video, the first reference portion is superimposed on the virtual second keyboard instrument placed in a virtual space. According to the aspect described above, a first reference portion is superimposed on a second keyboard instrument in the virtual space. Accordingly, it is possible to generate a composite video in which the performer appears to be playing various second keyboard instruments, including keyboard instruments that do not actually exist.

A video processing system according to one aspect (Aspect 9) of the present disclosure comprises: a video extraction unit for extracting, from a performance video representing a performance of a first keyboard instrument by a performer, a first reference portion that includes the hands of the performer; and a video generation unit for superimposing the first reference portion on a keyboard portion of a second keyboard instrument to generate a composite video.

A program according to one aspect (Aspect 10) of the present disclosure causes a computer system to function as: a video extraction unit for extracting, from a performance video representing a performance of a first keyboard instrument by a performer, a first reference portion that includes the hands of the performer; and a video generation unit for superimposing the first reference portion on a keyboard portion of a second keyboard instrument to generate a composite video.

What is claimed is:

1. A video processing method realized by at least one processor of a computer system, the method comprising:
extracting, from a performance video representing a performance of a first keyboard instrument by a performer, a first reference portion that includes a hand of the performer; and
superimposing the first reference portion on a keyboard portion of a second keyboard instrument, thereby generating a composite video.

2. The video processing method according to claim 1, wherein
the first reference portion further includes a keyboard of the first keyboard instrument.

3. The video processing method according to claim 1, further comprising
superimposing a second reference portion representing a content of a performance by the performer on the second keyboard instrument.

4. The video processing method according to claim 3, further comprising
extracting the second reference portion from the performance video.

5. The video processing method according to claim 1, further comprising
generating depth information representing a depth of a surface of the hand of the performer from the performance video,
wherein the depth of the surface of the hand of the performer in the first reference portion is controlled in accordance with the depth information.

6. The video processing method according to claim 1, further comprising
acquiring recorded video including the second keyboard instrument in real space from an imaging device,
wherein the first reference portion is superimposed on the keyboard portion of the second keyboard instrument in the recorded video.

7. The video processing method according to claim 6, further comprising
displaying the composite video on a display device,
wherein the display device and the imaging device are mounted on a head of a user.

8. The video processing method according to claim 1, wherein
the first reference portion is superimposed on the virtual second keyboard instrument placed in a virtual space.

9. A video processing system comprising:
a controller including memory storing instructions and at least one processor that implements the instructions, the instructions comprising
extracting, from a performance video representing a performance of a first keyboard instrument by a performer, a first reference portion that includes a hand of the performer; and
superimposing the first reference portion on a keyboard portion of a second keyboard instrument, thereby generating a composite video.

10. The video processing system according to claim 9, further comprising
superimposing a second reference portion representing a content of a performance by the performer on the second keyboard instrument.

11. The video processing system according to claim 9, further comprising
generating depth information representing a depth of a surface of the hand of the performer from the performance video,
wherein the depth of the surface of the hand of the performer in the first reference portion is controlled in accordance with the depth information.

12. The video processing system according to claim 9, further comprising
acquiring recorded video including the second keyboard instrument in real space from an imaging device,
wherein the first reference portion is superimposed on the keyboard portion of the second keyboard instrument in the recorded video.

13. The video processing method according to claim 12, further comprising
displaying the composite video on a display device,
wherein the display device and the imaging device are mounted on a head of a user.

14. The video processing system according to claim 9, wherein
the first reference portion is superimposed on the virtual second keyboard instrument placed in a virtual space.

15. A non-transitory computer-readable storage medium storing a program executable by at least one processor of a computer system to perform a video processing method, the video processing method comprising
extracting, from a performance video representing a performance of a first keyboard instrument by a performer, a first reference portion that includes a hand of the performer; and
superimposing the first reference portion on a keyboard portion of a second keyboard instrument, thereby generating a composite video.

16. The non-transitory computer-readable storage medium according to claim 15, further comprising
superimposing a second reference portion representing a content of a performance by the performer on the second keyboard instrument.

17. The non-transitory computer-readable storage medium according to claim 15, further comprising
generating depth information representing a depth of a surface of the hand of the performer from the performance video,
wherein the depth of the surface of the hand of the performer in the first reference portion is controlled in accordance with the depth information.

18. The non-transitory computer-readable storage medium according to claim 15, further comprising
acquiring recorded video including the second keyboard instrument in real space from an imaging device,
wherein the first reference portion is superimposed on the keyboard portion of the second keyboard instrument in the recorded video.

19. The non-transitory computer-readable storage medium according to claim 18, further comprising
displaying the composite video on a display device,
wherein the display device and the imaging device are mounted on a head of a user.

20. The non-transitory computer-readable storage medium according to claim 15, wherein
the first reference portion is superimposed on the virtual second keyboard instrument placed in a virtual space.
